(19) United States
(12) Patent Application Publication
(10) Pub. No.: US 2012/0213635 A1
(43) Pub. Date: Aug. 23, 2012

(54) WIND-POWER GENERATION DEVICE

(76) Inventor: TSO-TUNG LIN, Kaohsiung City (TW)

(21) Appl. No.: 13/207,430

(22) Filed: Aug. 11, 2011

(30) Foreign Application Priority Data
Feb. 22, 2011 (TW) 100105746

(51) Int. Cl. F03D 11/02

(52) U.S. Cl. 416/170 R

(57) ABSTRACT

The wind-power generation device contains a generator a power member having a gear box and a transmission box. The gear box contains a fan, a passive gear set, a transmission gear set, a supporting axle, and an output axle. The fan contains fan blades on an active axle with an active gear engaging the passive gear set. The passive gear set contains a first passive gear and a second passive gear. The transmission gear set contains a first transmission gear and a second transmission gear engaging each other. The first passive and transmission gears are mounted on the output axle with an output gear. The second passive gear and the second transmission gear are mounted on the supporting axle. The transmission box contains a transmission axle engaging the generator. A transmission gear on the transmission axle inside the transmission box is engaged by the output gear.

### (a) TECHNICAL FIELD OF THE INVENTION

The present invention is generally related to the harnessing of win power, and more particular to wind-power generation device capable of harnessing wind blown from various directions.

### (b) DESCRIPTION OF THE PRIOR ART

People's welfare is heavily dependent on electricity and the electrical power infrastructure is an indicator for advancement. Therefore all countries are devoted to the development of electrical power, hoping to provide a solid foundation to people's convenience and industrial development.

Electrical power is usually provisioned by thermo-electrical, hydraulic, wind-power, and nuclear means. The thermo-electrical means requires the burning of fossil fuel such as coal, natural gas, oil, etc. The carbon dioxide and ashes produced is a significant threat to environment protection, let alone that the fossil fuel has already been depleted. Due to the high cost paid, the thermo-electrical means is gradually replaced.

Nuclear means is able to provide low-cost and cleaner electricity. However, people cannot still quite effectively handle the associated nuclear contamination. The nuclear means as such is constantly questioned regarding its safety and environment hazard.

In terms of environmental protection, the hydraulic and wind-power means are better choices, especially there are less and less natural resources available. Therefore, these green technologies are top research and development topics for all countries. However, the hydraulic means requires steady water supply which is scarce, and usually causes heavy and costly influence to the terrain. In contrast, wind power is abundant and could be harnessed almost everywhere. The development of wind-power farm therefore has become a major goal to most countries.

How to provide an effective wind-power generation device as such is a primary task for research and development.

### SUMMARY OF THE INVENTION

A main objective of the present invention is to provide a wind-power generation device which contains a power member and a generator. The power member contains a gear box and a transmission box. The gear box contains a fan, a passive gear set, a transmission gear set, a supporting axle, and an output axle. The fan contains fan blades, an active axle, and an active gear. The fan blades are configured axially at an end of the active axle outside the gear box. The active axle extends into the gear box and is supported by bearings inside the gear box. The active gear is mounted axially on the active axle and engages the passive gear set. The passive gear set contains a first passive gear and a second passive gear. The first and second passive gears are configured on one-way bearings so that they can only spin in a specific direction. The transmission gear set contains a first transmission gear and a second transmission gear engaging each other. The first passive gear and the first transmission gear are mounted axially on the output axle. An output gear is inside the transmission box configured axially at an end of the output axle. The second passive gear and the second transmission gear are mounted axially on the supporting axle. The transmission box is attached to a side of the gear box and is coupled to the gear box by the output axle. The transmission box contains a transmission axle extending outside of the transmission box and engaging the generator. A transmission gear inside the transmission box is configured axially at an end of the transmission axle and is engaged by the output gear. The generator is capable of producing electricity when driven by the transmission axle.

The foregoing objectives and summary provide only a brief introduction to the present invention. To fully appreciate these and other objects of the present invention as well as the invention itself; all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the internals of a wind-power generation device according an embodiment of the present invention.

FIG. 2 is perspective diagram showing partially the power member of the wind-power generation device of FIG. 1.

FIG. 2A is an enlarged view of a portion of FIG. 2.

FIGS. 3 and 4 are schematic diagrams showing two power members of FIG. 1 cascaded together with their fan blades spinning in different directions.

FIGS. 5 and 6 are schematic diagrams showing multiple power members of FIG. 1 arranged in an array and along a curve.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

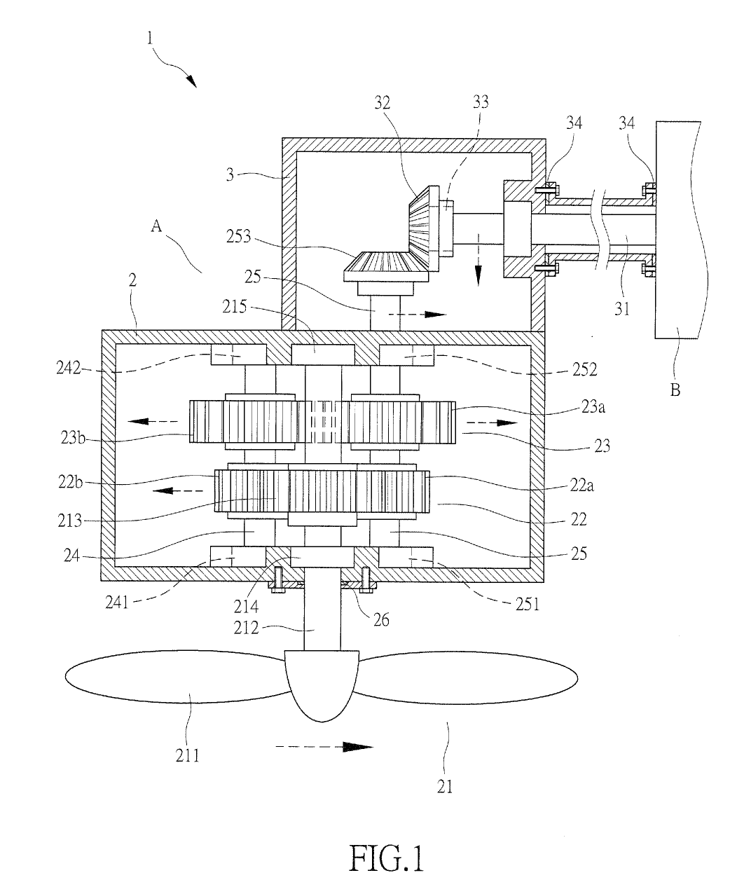

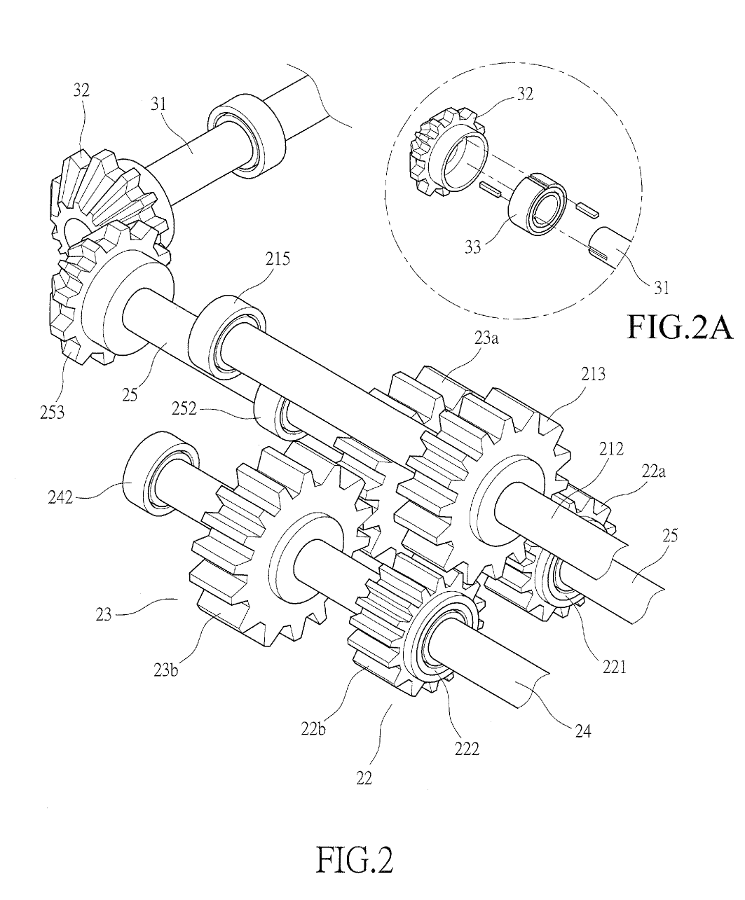

As shown in FIGS. 1, 2 and 2A, a wind-power generation device 1 according to an embodiment of the present invention contains a power member A and a generator B.

The power member A contains a gear box 2 and a transmission box 3.

The gear box 2 is filled with lubricant and is configured with a fan assembly 21. Inside the gear box 2, there are a passive gear set 22, a transmission gear set 23, a supporting axle 24, and an output axle 25. The fan assembly 21 contains fan blades 211, an active axle 212, and an active gear 213. The fan blades 211 outside the gear box 2 are configured axially at an end of the active axle 212 which extends into the gear box 2. An oil seal 26 is configured at the place where the active axle 212 enters the gear box 2 so as to prevent the lubricant inside the gear box 2 from leakage. The active axle 212 is supported inside the gear box 2 by bearings 214 and 215. The active gear set 213 is configured on the active axle 212, which engages the passive gear set 22. The passive gear set 22 contains a first passive gear 22a and a second passive gear 22b, which are configured on one-way bearings 221 and 222, respectively, so that the first and second passive gears 22a and 22b can only turn in one direction. The transmission gear set 23 contains a first transmission gear 23a and a second transmission gear 23b, which engage each other. The first passive gear 22a and the first transmission gear 23a are mounted axially on the output axle 25 which is supported by the bearings 251 and 252 inside the gear box 2. An output gear 253 inside the transmission box 3 is configured at a back end of the output axle 25. The second passive gear 22b and the second transmission gear 23b are mounted axially on the supporting axle 24 which is supported by the bearings 241 and 242 inside the gear box 2.

The transmission box 3 is attached to a back side of the gear box 2 and is filled with lubricant. The output axle 25 extends from inside the gear box 2 into the transmission box 3. The transmission box 3 contains a transmission axle 31 which extends from inside to outside of the gear box 3 to couple with the generator B. A transmission gear 32 inside the gear box 3 is configured axially at an end of the transmission axle 31, which engages the output gear 253. The transmission gear 32 is configured on a one-way bearing 33 so that the transmission gear 32 can only turn in one direction under the engagement of the output gear 253. An oil seal 34 is configured at the place where the transmission axle 31 enters the transmission box 3 so as to prevent the lubricant inside the transmission box 3 from leakage.

The generator B is capable of producing electricity when engaged by the transmission axle 31 of the transmission box 3.

To utilize the present invention, the wind-power generation device 1 is installed at a windy place. When the fan blades 211 are turned by wind, the active axle 212 and the active gear 213 are driven to turn as well. The active gear 213 in turn engages the passive gear set 22. Due to the one-way bearings 221 and 222 and depending on the rotational direction of the fan blades 211, only one of the first and second gears 22a and 22b of the passive gear set 22 will spin while the other will be idle. In other words, if the first passive gear 22a is turned by the active gear 213, the second passive gear 22b is idle. Similarly, if the second passive gear 22b is turned by the active gear 213, the first passive gear 22a is idle. Then, as the first passive gear 22a and the first transmission gear 23a are both mounted axially on the output axle 25, the second passive gear 22b and the second transmission gear 23b are both mounted axially on the supporting axle 24, and the first and second transmission gears 23a and 23b engage each other, the active gear 213 will cause the output axle 25 to run in a specific direction, no matter whether it is the first or second passive gear 22a or 22b is engaged by the active gear 213. Through the output gear 253's engaging the transmission gear 32, the output axle 25 drives the transmission axle 31 to spin and the generator B as such starts producing electricity.

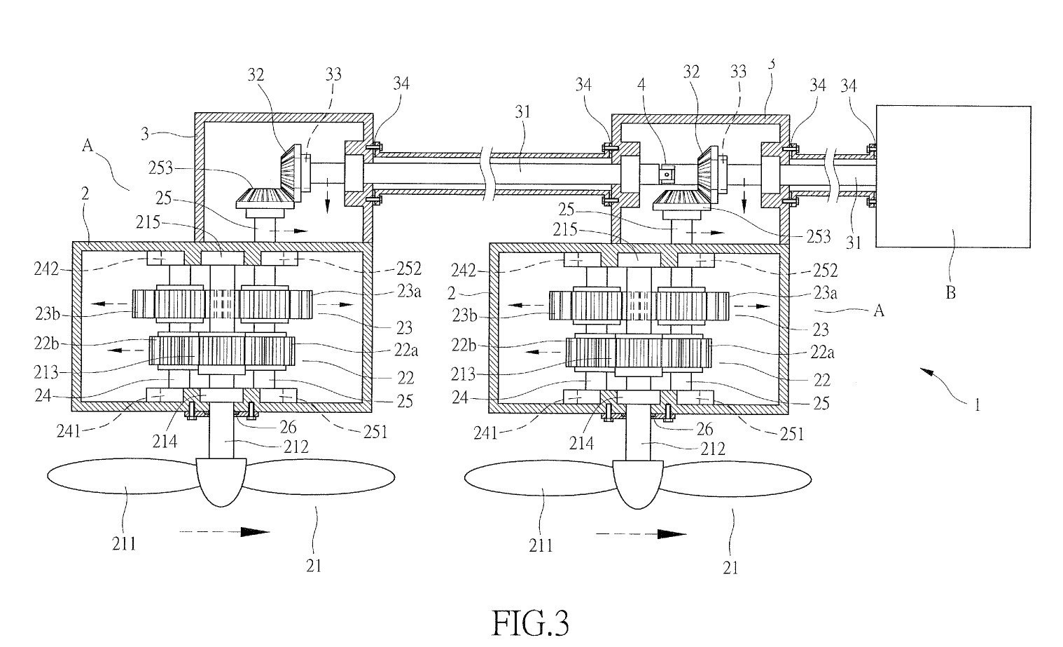

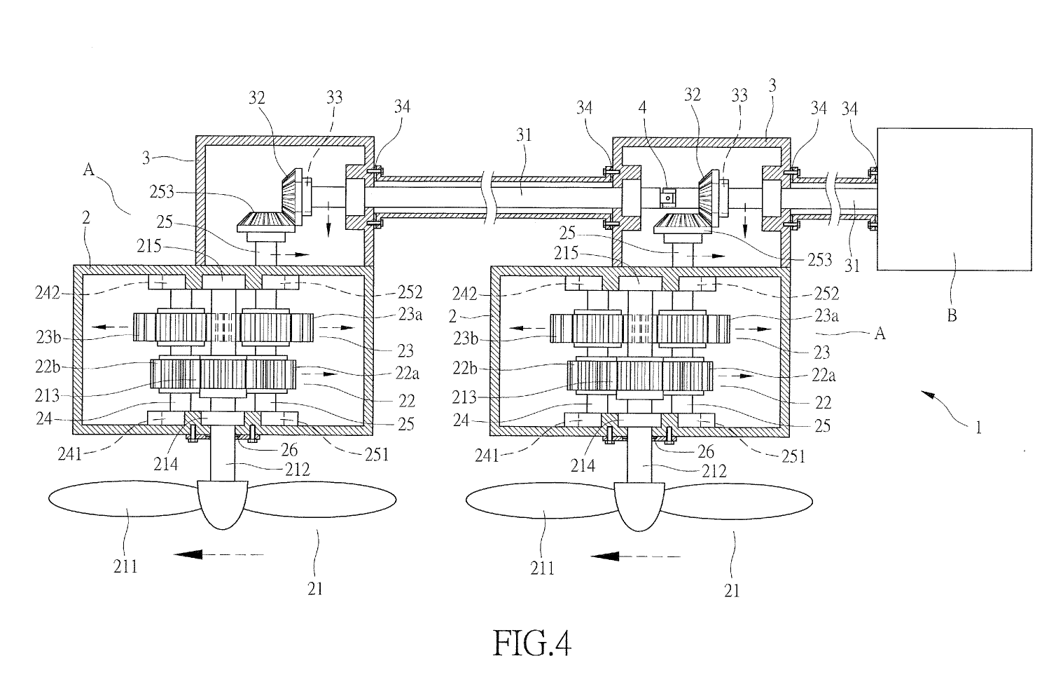

As shown in FIGS. 3 and 4, multiple power members A can be cascaded together by coupling the transmission axles 31 of neighboring power members A with a universal joint 4. As such, a single generator B is driven by multiple power members A. With the first and second passive gears 22a and 22b configured on the one-way bearings 221 and 222, and with the transmission gear 32 configured on the one-way bearing 33, the transmission axles 31 of the power members A will spin in a single direction so that the generator B will function properly.

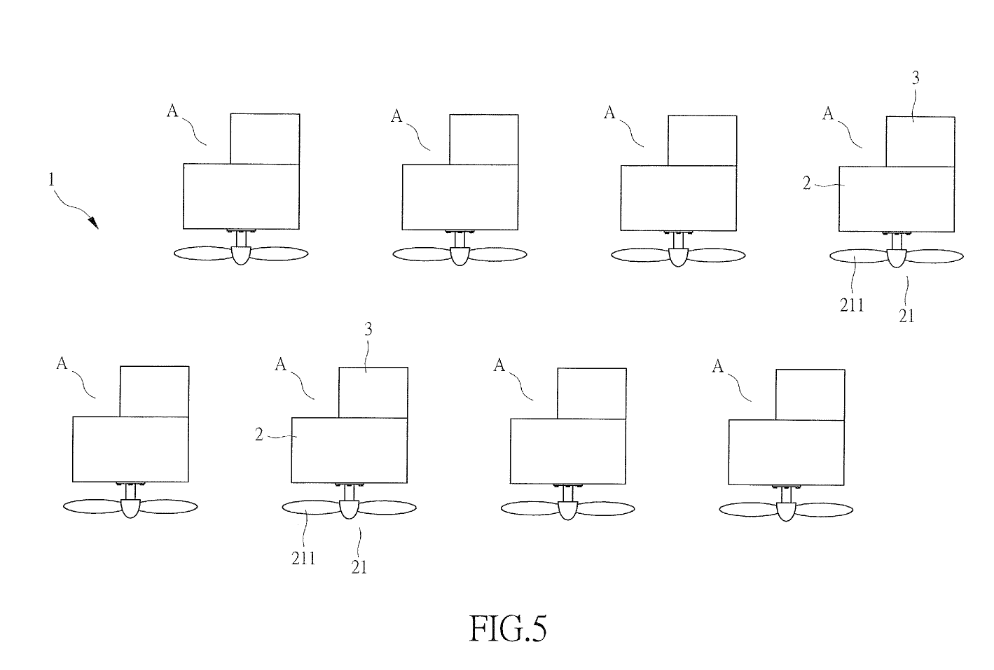

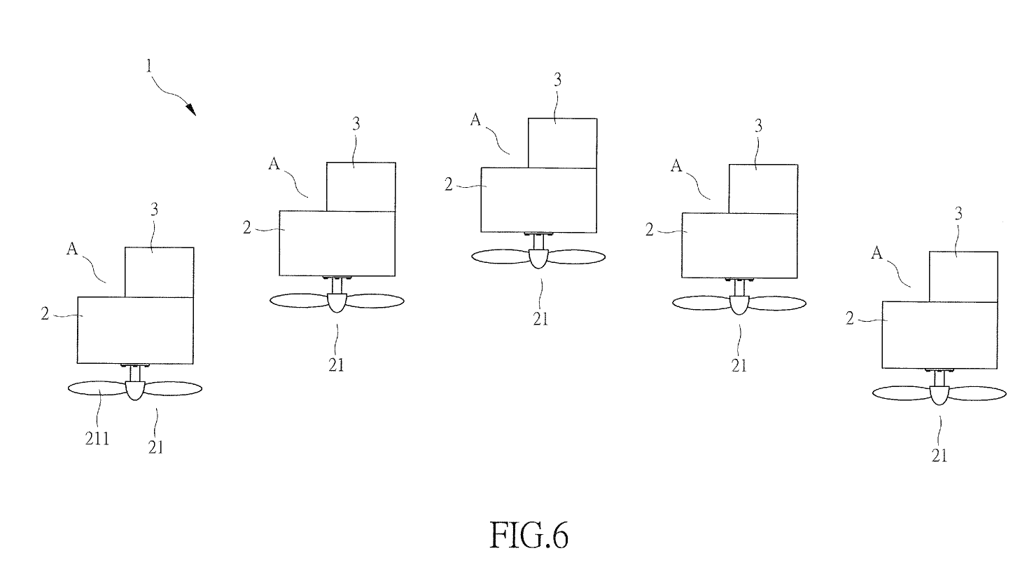

As shown in FIGS. 5 and 6, since multiple power members A can be cascaded together, the power members A can be arranged in an array or along a curve so that the fan blades 211 of different power members A could harness wind blown from various directions. As such, the generator B could be put into continuous operation to maintain a steady electricity output.

In summary, the present invention features that the first and second passive gears 22a and 22b are configured on the one-way bearings 221 and 222 so that the output axle 25 spins in a specific direction which in turn causes the transmission gear and axle 32 and 31 to spin in a specific direction as well. Then by coupling the transmission axles 31 of multiple power members A by universal joints 4, a single generator A could be driven by multiple power members A aiming at different directions to harness as much as wind power as possible.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wind-power generation device comprising a generator and a power member;
wherein
said power member comprises a gear box and a transmission box;
said gear box comprises a fan, a passive gear set, a transmission gear set, a supporting axle, and an output axle;
said fan comprises fan blades, an active axle, and an active gear;
said fan blades are configured axially at an end of said active axle outside said gear box;
said active axle extends into said gear box and is supported by at least a bearing inside said gear box;
said active gear is mounted axially on said active axle and engages said passive gear set;
said passive gear set comprises a first passive gear and a second passive gear;
said first and second passive gears are configured on one-way bearings, respectively, so that said first and second passive gears can only spin in a specific direction;
said transmission gear set comprises a first transmission gear and a second transmission gear engaging each other;
said first passive gear and said first transmission gear are mounted axially on said output axle;
an output gear is inside said transmission box configured axially at an end of said output axle;
the second passive gear and the second transmission gear are mounted axially on said supporting axle;
said transmission box is attached to a side of said gear box and is coupled to said gear box by said output axle;
said transmission box comprises a transmission axle extending outside of said transmission box and engaging said generator;
a transmission gear inside said transmission box is configured axially at an end of said transmission axle and is engaged by said output gear; and
said generator is capable of producing electricity when driven by said transmission axle.

2. The wind-power generation device according to claim 1, wherein an oil seal is configured at the place where said active axle extending outside said gear box.

3. The wind-power generation device according to claim 1, wherein said output axle is supported by at least a bearing inside said gear box.

4. The wind-power generation device according to claim 1, wherein said supporting axle is supported by at least a bearing inside said gear box.

5. The wind-power generation device according to claim 1, wherein said transmission gear of said transmission box is configured on a one-way bearing.

6. The wind-power generation device according to claim 1, wherein an oil seal is configured at the place where said transmission axle extending outside said transmission box.

7. The wind-power generation device according to claim 1, further comprising an additional power member coupled to said power member by an universal joint.

8. The wind-power generation device according to claim 7, wherein said power members are arranged in an array.

9. The wind-power generation device according to claim 7, wherein said power members are arranged along a curve.
